(19) United States
(12) Patent Application Publication
(10) Pub. No.: US 2026/0323594 A1
(43) Pub. Date: Oct. 15, 2026

(54) Extending an Active Time of Cell DTX for Low Latency Traffic

(71) Applicant: Apple Inc., Cupertino, CA (US)

(72) Inventors: Peng CHENG, Beijing (CN); Dan WU, Beijing (CN); Haijing HU, Los Gatos, CA (US); Jie CUI, San Jose, CA (US)

(21) Appl. No.: 19/483,071

(22) PCT Filed: May 10, 2023
(86) PCT No.: PCT/CN2023/093254

§ 371 Date: Nov. 10, 2025

(51) Int. Cl. H04W 68/02; H04L 1/1812; H04W 76/28

(52) U.S. Cl. CPC H04W 68/02; H04L 1/1812; H04W 76/28

(57) ABSTRACT

A user equipment (UE) is configured to receive a cell discontinuous transmission (DTX) configuration for a base station, wherein the cell DTX configuration comprises a cell DTX cycle comprising an active duration where the UE monitors for downlink (DL) signals from the base station and an inactive duration where the UE does not monitor for DL signals from the base station, receive a message from the base station, start a timer based on the message, wherein the timer runs for a predetermined duration and during the predetermined duration, monitor for DL signals from the base station, wherein at least a portion of the monitoring is performed during the inactive duration.

### TECHNICAL FIELD

This application relates generally to wireless communication systems, and in particular relates to extending an active time of cell DTX for low latency traffic.

### BACKGROUND

Cell discontinuous reception (DRX) and discontinuous transmission (DTX) are modes of operation for New Radio (NR) which reduces signaling and power draw at a network device (e.g., a cell). Typically, when a cell is operating in DRX/DTX mode, a user equipment (UE) and the network negotiate phases in which data transfer occurs. During other times the cell may transition transmitters/receivers to a low power state and the UE may also transition transmitters/receivers to a low power state.

### SUMMARY

Some exemplary embodiments are related to a method performed by a user equipment (UE). The method includes receiving a cell discontinuous transmission (DTX) configuration for a base station, wherein the cell DTX configuration comprises a cell DTX cycle comprising an active duration where the UE monitors for downlink (DL) signals from the base station and an inactive duration where the UE does not monitor for DL signals from the base station, receiving a message from the base station, starting a timer based on the message, wherein the timer runs for a predetermined duration and during the predetermined duration, monitoring for DL signals from the base station, wherein at least a portion of the monitoring is performed during the inactive duration.

Other exemplary embodiments are related to a method performed by a user equipment (UE). The method includes receiving a cell discontinuous transmission (DTX) configuration for a base station, wherein the cell DTX configuration comprises a cell DTX cycle comprising an active duration where the UE monitors for downlink (DL) signals from the base station and an inactive duration where the UE does not monitor for DL signals from the base station, receiving a UE dedicated PDCCH from the base station during the active duration and determining whether the UE is operating in Connected Discontinuous Reception (C-DRX) mode.

Still further exemplary embodiments are related to a method performed by a base station. The method includes transmitting, to a user equipment (UE), a cell discontinuous transmission (DTX) configuration for the base station, wherein the cell DTX configuration comprises a cell DTX cycle comprising an active duration where the UE monitors for downlink (DL) signals from the base station and an inactive duration where the UE does not monitor for DL signals from the base station and transmitting a message to the UE, wherein the message causes the UE to monitor for DL signals from the base station during a portion of the inactive duration, wherein the DL signals comprise Physical Downlink Control Channel (PDCCH) signals comprising a Cell Radio Network Temporary Identifier (C-RNTI) corresponding to the UE.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an exemplary cell DTX cycle according to various exemplary embodiments.

FIG. 5 shows a first exemplary cell DTX cycle that includes an extended active duration according to various exemplary embodiments.

FIG. 6 shows a second exemplary cell DTX cycle that includes an extended active duration according to various exemplary embodiments.

FIG. 7 shows a third exemplary cell DTX cycle that includes an extended active duration according to various exemplary embodiments.

### DETAILED DESCRIPTION

The exemplary embodiments may be further understood with reference to the following description and the related appended drawings, wherein like elements are provided with the same reference numerals. The exemplary embodiments relate to improvements to improving reception of downlink data by a UE during cell DTX mode.

The exemplary embodiments are described with regard to a UE. However, reference to a UE is merely provided for illustrative purposes. The exemplary embodiments may be utilized with any electronic component that may establish a connection to an accessory device and is configured with the hardware, software, and/or firmware to exchange information and data with accessory devices. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol, or any other type of network.

As stated above, cell DRX/DTX are modes of operation which offer potential energy savings to the network. In cell DRX/DTX mode, the cell is configured with a DRX/DTX cycle that includes an active duration where the cell is transmitting and receiving and an inactive duration where the cell is not transmitting and receiving. Those skilled in the art will understand that the cell may not stop all transmission/reception during the inactive duration but may perform less transmissions/receptions than in the active duration.

The cell DRX/DTX cycle may be configured by a gNB via UE-specific RRC signaling per serving cell, e.g., the gNB signals the UE to indicate the cell DRX/DTX configuration so that the UE 110 is aware of the parameters of the cell DRX/DTX cycle of the gNB and when the cell DRX/DTX mode is activated or deactivated. The cell DTX/DRX mode can be activated/de-activated via dynamic Layer 1 (L1) or Layer 2 (L2) signaling and UE-specific RRC signaling. The UE specific and the common L1/L2 signaling may be used for activating/deactivating the Cell DTX/DRX mode. In addition, the cell DTX and cell DRX modes may be configured and operated separately (e.g., one RRC configuration set for downlink (DL) and another for uplink (UL)) or may also be configured and operated together. The exemplary embodiments are related to DL data and thus the cell mode of interest is the cell DTX mode. Therefore, throughout this description, the cell operating mode will be described as cell DTX but as described above, the cell DRX mode may be configured with the same parameters as the cell DTX mode.

A UE may have a corresponding power saving mode also termed DRX where the UE will place a receiver into a lower power mode to save power. The UE DRX mode may also have a DRX cycle with an active duration (sometimes called an OnDuration) where the receiver(s) of the UE are in a full power mode to receive transmissions from the cell and an inactive duration where the receiver(s) are placed in a lower power mode.

In the exemplary embodiments, it may be considered that the UE is in a Radio Resource Control (RRC) Connected state with the cell, e.g., the cell and the UE are actively engaged in a data exchange. Specifically, the cell may be transmitting data to the UE during the DTX cycle of the cell and the UE may be receiving the data during the DRX cycle of the UE. When the UE is in the RRC Connected state, the DRX cycle may be termed a Connected DRX (C-DRX) cycle. It should be understood that the exemplary embodiments do not require the UE to be in C-DRX mode, e.g., the exemplary embodiments may be implemented when the UE is operating in a normal mode, e.g., full power mode without DRX being enabled.

There may be different types of data exchanges between the cell and the UE. Some of these data exchanges may be low latency data exchanges, e.g., the data should be delivered to the UE in a timely manner. When the cell is in the DTX mode and the UE is in the C-DRX mode, there may be delays in delivering the data to the UE. The exemplary embodiments are related to enhancements of the cell DTX mode including the alignment of cell DTX cycles with the UE C-DRX cycle and manners of improving data exchange for low latency data when the cell is in the DTX mode and the UE is in the C-DRX mode. Each of these exemplary embodiments will be described in greater detail below.

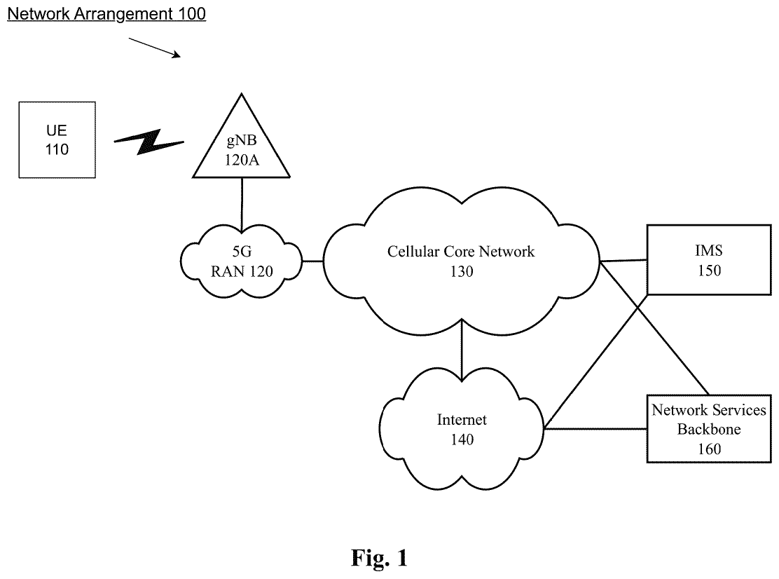

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of one UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A). There may also be one or more neighboring cells with which the UE may communicate with prior to a handover operation. One additional neighbor cell is shown in FIG. 1 with gNB 120B, but one of skill in the art will recognize that a UE may have more than one neighbor cells available for handover.

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

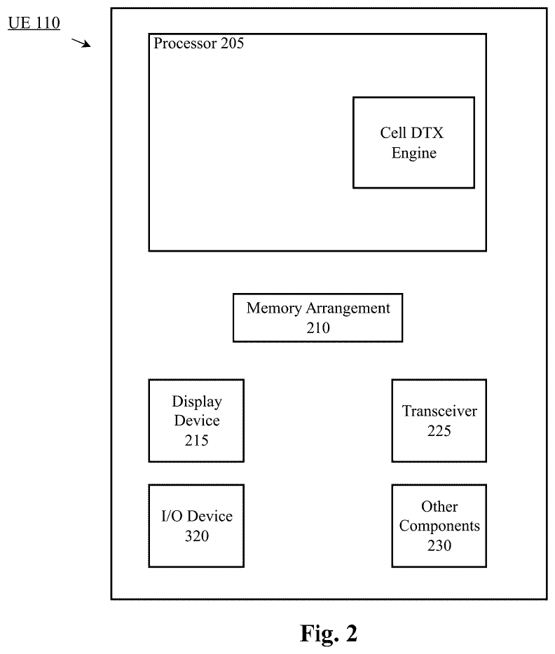

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a cell DTX engine 235 for performing operations related to improving reception of DL data by the UE 110 during cell DTX mode. The operations include, but are not limited to, starting a timer that runs during an inactive duration of the cell DTX cycle in response to receiving a paging message, a group/cell common Physical Downlink Control Channel (PDCCH) or a UE dedicated PDCCH and monitoring for PDCCH from a cell during an inactive duration of the DTX cycle. These exemplary operations will be described in greater detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies).

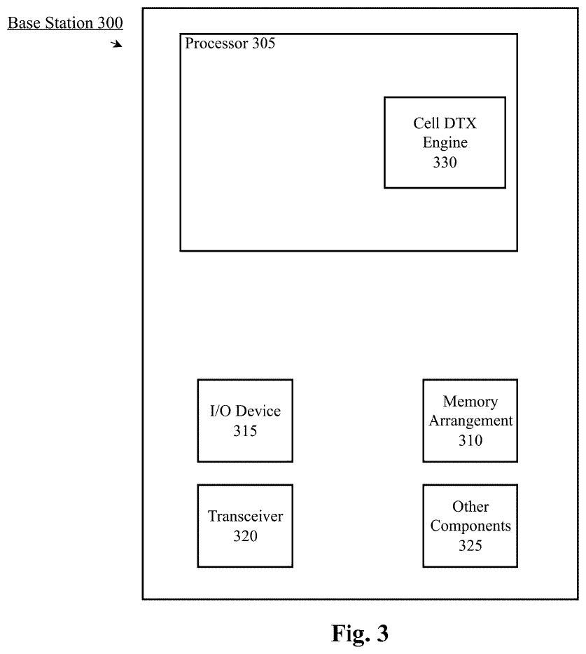

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a Cell DTX engine 330 for performing operations related to improving reception of DL data by the UE 110 during cell DTX mode. The operations include, but are not limited to, configuring the UE 110 with a timer that runs during an inactive duration of the cell DTX cycle in response to receiving a paging message, a group/cell common Physical Downlink Control Channel (PDCCH) or a UE dedicated PDCCH and transmitting PDCCH for the DL data during an inactive duration of the DTX cycle. These exemplary operations will be described in greater detail below

The memory arrangement 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

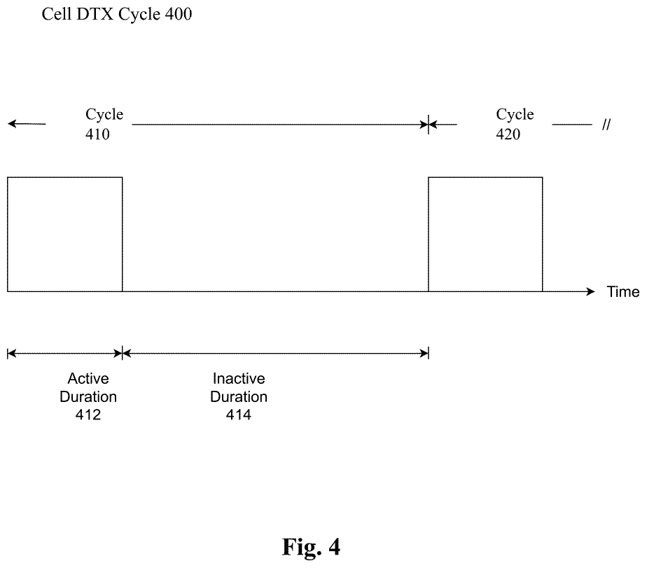

FIG. 4 shows an exemplary cell DTX cycle 400 according to various exemplary embodiments. In the following examples, it may be considered that the gNB 120A is the cell. FIG. 4 shows a complete first DTX cycle 410 and the start of a second DTX cycle 420. The DTX cycle 410 (and all subsequent cycles) comprise an active duration 412 and an inactive duration 414. As described above, in the active duration 412 the gNB 120A is in full power operation and is transmitting and receiving with one or more UEs. In the inactive duration 414, the gNB 120B enters lower power operations where certain transmission and reception operations may not be performed. As described above, the gNB 120A may provide the UE 110 with the cell DTX configuration. The cell DTX configuration may include a periodicity of the DTX cycle 400, a starting slot or slot offset of the DTX cycle 400, an active duration length DTX cycle 400, etc.

As also described above, the UE 110 may also implement DRX. In these exemplary embodiments, it may be considered that the DRX cycle of the UE 110 and the cell DTX cycle of the gNB 120A are aligned, e.g., the active duration 412 of the cell DTX cycle 410 is also the active duration of the UE 110 DRX cycle and the inactive duration 414 of the cell DTX cycle 410 is also the inactive duration of the UE 110 DRX cycle. The gNB 120A may configure the DRX cycle of the UE 110 to accomplish this alignment.

As stated above, the exemplary embodiments are related to manners of improving data exchange for low latency data when the cell is in the DTX mode and the UE is in the C-DRX mode. This may be accomplished by extending the active time of the cell DTX cycle to allow the UE to receive low latency DL traffic during the inactive duration. The following will provide exemplary manners of extending the active time.

It should be understood that the general characteristics of the cell DTX cycle 400 may also apply to the exemplary cell DTX cycles described below, e. g., configured by UE-specific RRC signaling per serving cell, activated/de-activated via dynamic L1/L2 signaling, Layer 1 (L1) or Layer 2 (L2), DRX and DTX configured together or separately, etc. Thus, these general characteristics will not be described again below.

In the following exemplary embodiments, various timers are described. In some cases, the timers are described as new timers and in other cases, the timers are described as exiting timers. It should be understood that these terms are merely used for convenience in describing the timers. For example, the timers that are described as new timers may be implemented using an existing timer by altering the exiting timer or adding a new functionality to the existing timer. Similarly, the new functionality described for an existing timer may be implemented in a new timer. Furthermore, the use of specific names for the timers is also only exemplary and other names may be used to refer to the timers having the functionality described herein.

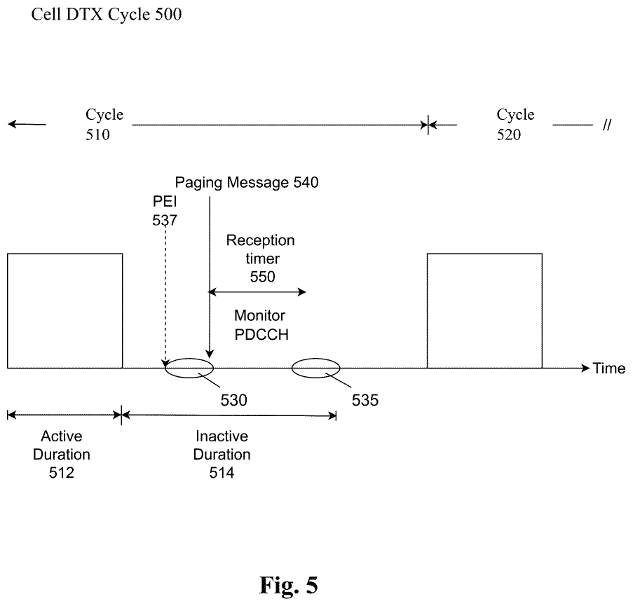

In some exemplary embodiments, a new timer (e.g., receptionTimer) may be configured for the UE 110. This new timer may be configured via RRC signaling from the gNB 120A. As will be described in greater detail below, when the receptionTimer is configured, the UE 110 operating in C-DRX mode may monitor paging occasions (POs) that occur during the inactive mode of the gNB 120A DTX cycle and UE 110 DRX cycle. The monitoring of these POs may be the basis for extending the active duration of the DTX cycle. These exemplary embodiments will be described with reference to FIG. 5.

FIG. 5 shows a first exemplary cell DTX cycle 500 that includes an extended active duration according to various exemplary embodiments. Again, FIG. 5 shows a complete first DTX cycle 510 and the start of a second DTX cycle 520. The DTX cycle 510 (and all subsequent cycles) comprise an active duration 512 and an inactive duration 514. The operations described below may be considered to be performed by the gNB 120A operating in DTX mode and the UE 110 operating in C-DRX mode.

FIG. 5 shows that there are two POs 530 and 535 that occur in the inactive duration 514 where the gNB 120A may send paging messages to the UE 110. The POs 530 and 535 are configured times within the inactive time where the UE 110 may listen for paging messages from the gNB 120A. In the example of FIG. 5, the POs 530 and 535 are shown as ellipses because it should be understood that the paging messages may be sent at any time during the POs 530 and 535. As described above, the UE 110 operating in C-DRX mode may monitor the POs that occur in the inactive duration 514 (e.g., POs 530 and 535).

In the example of FIG. 5, it may be considered that the UE 110 received a paging message 540 during the PO 530. As will be described in greater detail below, there may be different type of paging messages or different information that is included in the paging message. The exemplary embodiments may be used with any type of paging message or paging message with any type of information. Manners of handling exemplary types of paging messages or paging messages with different types of information will be described in greater detail below. In the exemplary embodiments, paging messages with scheduling information will start the timer as described below. This may, for example, preclude paging with only a System Information Block (SIB) update indication from starting the timer.

In the present example, it may be considered that the UE 110 monitors the PO 530 and receives the paging message 540 from the gNB 120A. Upon receipt of the paging message 540, the UE 110 will start the new timer (e.g., receptionTimer 550). The duration of the receptionTimer 550 may be configured by the network (e.g., by the gNB 120A in the RRC signaling configuring the receptionTimer 550) or may be defined in standards (e.g., 3GPP standards). In the example of FIG. 5, the duration of the receptionTimer 550 is from the receipt of the paging message 440 until the start of the next PO 535. However, this duration is only exemplary and other durations may be used.

While the receptionTimer 550 is running, the UE 110 will monitor the Physical Downlink Control Channel (PDCCH) of the gNB 120A to determine if any DL data transmissions are scheduled for the UE 110, e.g., the UE 110 monitors for PDCCH having the correct Cell Radio Network Temporary Identifier (C-RNTI). For example, the UE 110 may receive PDCCH that includes Downlink Control Information (DCI) that indicates the UE 110 is to receive DL data on a Physical Downlink Shared Channel (PDSCH). Thus, as can be seen from FIG. 5, when the receptionTimer 550 is running, the UE 110 is monitoring PDCCH during the inactive duration 514.

Normally, the gNB 120A would not transmit PDCCH during the inactive duration 514. However, in the above example, the gNB 120A has configured the UE 110 with the receptionTimer 550. Thus, the gNB 120A is aware that the UE 110 will be monitoring POs when in the C-DRX mode. Therefore, if the gNB 120A has data for the UE 110, the gNB 120A has the option of delivering the data during the inactive duration 514. As can be seen from the above example, this is one manner of extending the active duration of the cell DTX cycle.

As stated above, in the described example, if the gNB 120A has data for the UE 110, the gNB 120A has the option of delivering the data during the inactive duration 514. The gNB 120A is not required to send the data during the inactive duration 514. For example, the data that the gNB 120A has for the UE 110 may be lower priority data. In this example, the gNB 120A may wait for the next active duration, e.g., the active duration of the DRX/DRX cycle 520, to schedule the DL data transmission to the UE 110. On the other hand, if the data is low latency data, the gNB 120A may schedule the DL data transmission to the UE 110 during the extended active duration of the DRX/DRX cycle 510. In some example, the gNB 120A may schedule the DL data transmission during the inactive duration based on the type of the data or a priority of the data.

To continue with the above example, the UE 110 has received the paging message 540 and has started the receptionTimer 550. During the running duration of the receptionTimer 550 (which is in the inactive duration 514), the UE 110 monitors the PDCCH from the gNB 120A. If the UE 110 receives PDCCH from the gNB 120A indicating DL data has been scheduled for the UE 110, the UE 110 will operate in accordance with the DL scheduling information and receive the DL data. If the UE 110 does not receive PDCCH from the gNB 120A during the time the receptionTimer 550 is running, the UE 110 will terminate monitoring for PDCCH when the receptionTimer 550 expires. The UE 110 will then monitor the next PO 535 during the inactive duration to determine whether a paging message is received during this PO 535. In the example, no paging message is received during the PO 535, so the UE 110 operates in accordance with the configured DRX cycle, e.g., remains in the lower power state until the start of the active duration of the DTX cycle 520. If, however, the UE 110 had received a paging message during the PO 535, the UE 110 would operate in the same manner as described above when receiving the paging message 540 during the PO 530, e.g., start the receptionTimer 550 and monitor for PDCCH from the gNB 120A during the duration of the receptionTimer 550.

As described above, there may be different types of paging messages or paging messages that have different types of information that are sent during the POs. In some exemplary embodiments, the UE 110 may start the receptionTimer 550 immediately upon detection of a paging message in the PO. It should be understood that multiple UEs may share the same PO, e.g., in addition to UE 110, one or more additional UEs that are associated with the gNB 120A may use the POs 530 and 535. Thus, if the gNB 120A sends the paging message 540 in the PO 530, each of these UEs that are in the C-DRX mode will start their corresponding receptionTimer and monitor for PDCCH from the gNB 120A. However, the gNB 120A may not have data for all the UEs and therefore, some UEs may be monitoring for PDCCH during the duration of the receptionTimer for no reason.

An example of a different type of paging message is an early paging indication (PEI) that was introduced in Rel. 17 of the 5G standards. For example, in some exemplary embodiments, at the start of the PO (e.g., PO 530), the gNB 120A may send a PEI 537 to indicate that the UE 110 should expect to receive a paging message during the PO 530. If the PEI 537 is not received, the UE 110 may skip monitoring the PO 530 because the UE 110 does not expect to receive a paging message during the PO 530. In the exemplary embodiments, the UE 110 may start the receptionTimer 550 upon receipt of the PEI 537 rather than the paging message 540 because the UE 110, upon receipt of the PEI 537, will understand that the paging message 540 is going to be received. However, it should be understood that the gNB 120A is not required to send a PEI, e.g., if the gNB 120A is not configured to send PEI, the UE 110 may listen for paging messages during the duration of each of the POs occurring in the inactive duration.

In other exemplary embodiments, the UE 110 may start the receptionTimer 550 when the UE 110 has verified that the paging message includes the UE identification (UE ID). As described above, in some exemplary embodiments, upon receipt of the paging message, the UE 110 will start the receptionTimer 550. However, because multiple UEs may share the same PO, the paging message in the PO may not be directed at the UE 110. In these exemplary embodiments, the UE 110 will not start the receptionTimer 550 until the UE 110 verifies the UE ID in the paging message 540 is the UE ID of the UE 110. This may prevent the UE 110 from wasting power monitoring for PDCCH when the paging message 540 is not intended for the UE 110.

In further exemplary embodiments, the UE 110 may start the receptionTimer 550 when the UE 110 verifies the UE ID in the paging message 540 and the pagingCause indicates “voice,” e.g., the pagingCause may indicate the type of data that is to be received and in this case “voice” data has been identified as low latency DL data that may be scheduled during the inactive time. If the UE 110 does not identify the correct UE ID and pagingCause in the paging message 540, the UE 110 will not start the receptionTimer 550 and will therefore not monitor the PDCCH during the inactive time.

The exemplary embodiments using the UE ID or the UE ID and the pagingCause may resolve the issue of some UEs unnecessarily monitoring the PDCCH, but may introduce an issue related to the time for UE 110 to process the paging message 540, e.g., there is a possibility that the gNB 120A will send a PDCCH for the UE 110 during the time the UE 110 is decoding and processing the paging message 540 to verify the UE ID or the UE ID and the pagingCause. The UE 110 would not receive this PDCCH because the receptionTimer 550 would not yet be running, so the UE 110 would not be monitoring the PDCCH.

It should be understood that despite the fact that there may be some minor issues related to the above exemplary embodiments, these exemplary embodiments are valid and usable solutions for extending the active duration of the cell DTX cycle.

In additional exemplary embodiments, the above exemplary embodiments may be combined. For example, the UE 110 may start the receptionTimer 550 immediately upon the receipt of the paging message 540 (or the PEI 537) and begin monitoring the PDCCH of the gNB 120A. However, if after decoding and processing the paging message 540, the UE determines the paging message 540 does not include the UE ID or the UE ID and the pagingCause, the UE 110 may stop the receptionTimer 550 and discontinue monitoring the PDCCH.

In some exemplary embodiments, RRC may also configure whether retransmissions are allowed, e.g., Hybrid Automatic Repeat request (HARQ) retransmissions. If retransmissions are allowed, the UE may follow a legacy UE DRX behavior where the UE starts a HARQ-RTT-timer after transmission of a HARQ ACK/NACK (e.g., HARQ feedback) and after the HARQ-RTT-timer expires, the UE wakes up to monitor PDCCH for retransmissions by starting a HARQ-ReTX-timer. If retransmissions are not allowed, the UE stops the HARQ-RTT-timer or the HARQ-ReTX-timer (if running), or alternatively the UE simply refrains from starting the HARQ-RTT-timer.

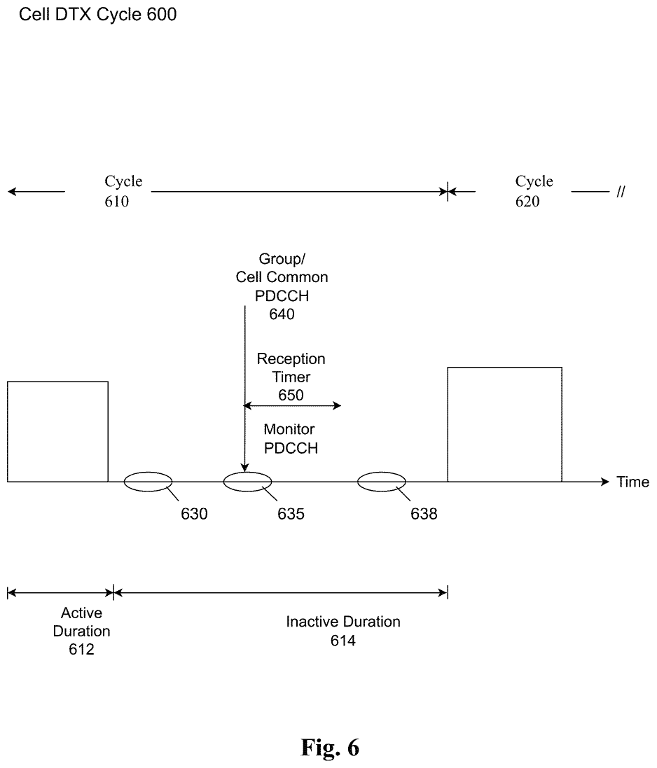

In other exemplary embodiments, a new timer (e.g., receptionTimer) may be configured for the UE 110. This new timer may be configured via RRC signaling from the gNB 120A. The new timer is described as having the same name as the new timer for the above exemplary embodiments but the new timer in the following exemplary embodiments may be started using different conditions from the timer described above. As will be described in greater detail below, when the receptionTimer is configured, the UE 110 operating in C-DRX mode may monitor configured periodic resources that occur during the inactive mode of the gNB 120A DTX cycle and UE 110 DRX cycle. The monitoring of these configured periodic resources may be the basis for extending the active duration of the DTX cycle. These exemplary embodiments will be described with reference to FIG. 6.

FIG. 6 shows a second exemplary cell DTX cycle 600 that includes an extended active duration according to various exemplary embodiments. Again, FIG. 6 shows a complete first DTX cycle 610 and the start of a second DTX cycle 620. The DTX cycle 610 (and all subsequent cycles) comprise an active duration 612 and an inactive duration 614. The operations described below may be considered to be performed by the gNB 120A operating in DTX mode and the UE 110 operating in C-DRX mode.

FIG. 6 shows that there are three configured periodic resources 630, 635 and 638 that occur in the inactive duration 614. As part of the cell DTX configuration information (or any other configuration) received by the UE 110, configuration information may be received for the configured periodic resources 630, 635 and 638. This configuration information may include the periodicity of the configured periodic resources, the duration of the configured periodic resources, an offset (e.g., slot, symbol, etc.) of the configured periodic resources, etc.

The configured periodic resources 630, 635 and 638 are configured times within the inactive time where the UE 110 may listen for group/cell common PDCCH from the gNB 120A. It should be understood that group/cell common PDCCH comprise DCI formats that address a group of UEs, e.g., the UE 110 and additional UEs having a Radio Network Temporary Identifier (RNTI) included in the group/cell common PDCCH. For example, the group/cell common RNTI may be a paging short message, DCI 2-6, DCI 2-7, or a new UE group common DCI. In the exemplary embodiments, the group/cell common PDCCH includes a new indication as to whether the active time of the cell DTX cycle should be extended as will be described in greater detail below. The group/cell common PDCCH may also include an indication that the cell DTX should be deactivated.

In the example of FIG. 6, the configured periodic resources 630, 635 and 638 are shown as ellipses because it should be understood that the group/cell common PDCCH may be sent at any time during the configured periodic resources 630, 635 and 638. As described above, the UE 110 operating in C-DRX mode may monitor the configured periodic resources 630, 635 and 638 that occur in the inactive duration 614.

In the example of FIG. 6, it may be considered that the UE 110 monitors for the group/cell common PDCCH during the configured periodic resource 630. Since no group/cell common PDCCH was received, the UE 110 transitions back to the low power state. The UE 110 again monitors for the group/cell common PDCCH during the configured periodic resource 635. In this example, the UE 110 receives the group/cell common PDCCH 640 during the configured periodic resource 635. Upon receipt of the group/cell common PDCCH 640, the UE 110 will start the new timer (e.g., receptionTimer 650). The duration of the receptionTimer 650 may be configured by the network (e.g., by the gNB 120A in the RRC signaling configuring the receptionTimer 650), or in the group/cell common PDCCH instructing the extended active duration or may be defined in standards (e.g., 3GPP standards). Thus, the duration of the receptionTimer 650 shown in FIG. 6 is only exemplary and other durations may be used.

While the receptionTimer 650 is running, the UE 110 will monitor the Physical Downlink Control Channel (PDCCH) of the gNB 120A to determine if any DL data transmissions are scheduled for the UE 110, e.g., the UE 110 monitors for PDCCH having the correct C-RNTI. For example, the UE 110 may receive PDCCH that includes DCI that indicates the UE 110 is to receive DL data on the PDSCH. Thus, as can be seen from FIG. 6, when the receptionTimer 650 is running, the UE 110 is monitoring PDCCH during the inactive duration 614.

Normally, the gNB 120A would not transmit PDCCH during the inactive duration 614. However, in the above example, the gNB 120A has configured the UE 110 with the receptionTimer 650. Thus, the gNB 120A is aware that the UE 110 will be monitoring the configured periodic resources 630, 635 and 638 for group/cell common PDCCH when in the C-DRX mode. Therefore, if the gNB 120A has data for the UE 110, the gNB 120A has the option of delivering the data during the inactive duration 614. As can be seen from the above example, this is another manner of extending the active duration of the cell DTX cycle. As described above, the gNB 120A may take advantage of the extended active duration to transmit low latency DL data to the UE 110.

To continue with the above example, the UE 110 has received the group/cell common PDCCH 640 and has started the receptionTimer 650. During the running duration of the receptionTimer 650 (which is in the inactive duration 614), the UE 110 monitors the PDCCH from the gNB 120A. If the VE 110 receives PDCCH from the gNB 120A indicating DL data has been scheduled for the UE 110, the UE 110 will operate in accordance with the DL scheduling information and receive the DL data. If the UE 110 does not receive PDCCH from the gNB 120A during the time the receptionTimer 650 is running, the UE 110 will terminate monitoring for PDCCH when the receptionTimer 650 expires. The UE 110 will then monitor the next configured periodic resource 638 during the inactive duration 614 to determine whether a group/cell common PDCCH is received during this configured periodic resource 638. In the example, no group/cell common PDCCH is received during the configured periodic resource 638, so the UE 110 operates in accordance with the configured DRX cycle, e.g., remains in the lower power state until the start of the active duration of the DTX cycle 620. If, however, the UE 110 had received a group/cell common PDCCH during the configured periodic resource 638, the UE 110 would operate in the same manner as described above when receiving the group/cell common PDCCH 640 during the configured periodic resource 635, e.g., start (or extend) the receptionTimer 650 and monitor for PDCCH from the gNB 120A during the duration of the receptionTimer 650.

Similar to the above exemplary embodiments, RRC may also configure whether retransmissions are allowed. If retransmissions are allowed, the UE may follow a legacy UE DRX behavior as described above. If retransmissions are not allowed, the UE stops the HARQ-RTT-timer or the HARQ-ReTX-timer (if Hankun running), or alternatively the UE simply refrains from starting the HARQ-RTT-timer.

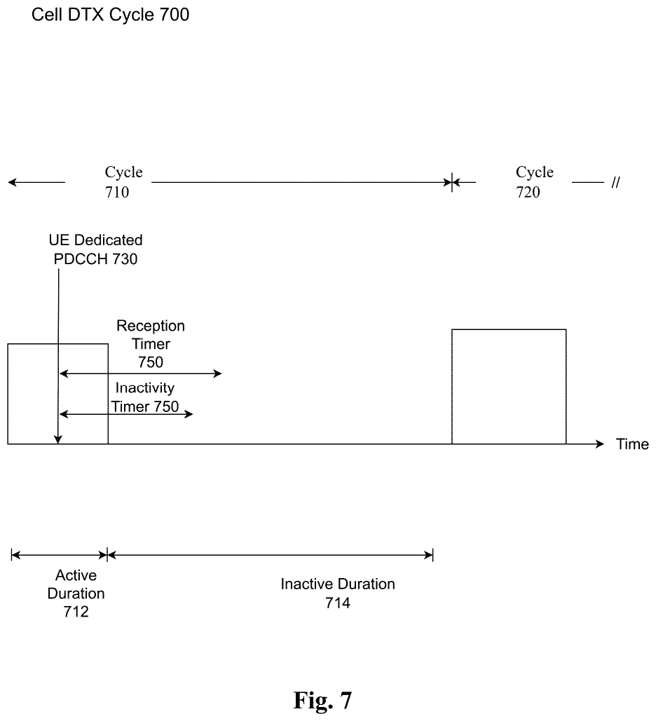

In still further exemplary embodiments, a new timer (e.g., a receptionTimer) may be configured for the UE 110 to be used in conjunction with an existing inactivityTimer for C-DRX. The new timer may be configured via RRC signaling from the gNB 120A. The new receptionTimer is described as having the same name as the new timer for the above exemplary embodiments but the new timer in the following exemplary embodiments may be started using different conditions from the timers described above. In contrast to the above exemplary embodiments, these exemplary embodiments may be used to extend the active duration around the boundary of the cell DTX. The exemplary embodiments implementing the receptionTimer and inactivityTimer will be described with reference to FIG. 7.

FIG. 7 shows a third exemplary cell DTX cycle 700 that includes an extended active duration according to various exemplary embodiments. Again, FIG. 7 shows a complete first DTX cycle 710 and the start of a second DTX cycle 720. The DTX cycle 710 (and all subsequent cycles) comprise an active duration 712 and an inactive duration 714. The operations described below may be considered to be performed by the gNB 120A operating in DTX mode and the UE 110.

During the active duration 712, the UE 110 will monitor transmissions from the gNB 120A. As stated above, the gNB 120A may be in DTX mode. The UE 110 may or may not be in C-DRX mode. In these exemplary embodiments, the UE 110 may operate differently in the two different scenarios: (1) gNB 120A in DTX mode and UE 110 not in C-DRX mode; and (2) gNB 120A in DTX mode and UE 110 in C-DRX mode.

Initially, the first scenario will be considered, e.g., gNB 120A in DTX mode and UE 110 not in C-DRX mode, with reference to FIG. 7. As shown in FIG. 7, the UE 110 may receive a UE dedicated PDCCH 730 during the active duration 712. Since the UE 110 is not in the C-DRX mode and the inactivityTimer 750 is a timer associated with the C-DRX mode, the inactivityTimer 750 is not started at this time. In contrast, upon reception of the UE dedicated PDCCH 730 during the active duration, the UE 110 starts the receptionTimer 740. The duration of the receptionTimer 740 may be configured by the network (e.g., by the gNB 120A in the RRC signaling configuring the receptionTimer 740), in the UE dedicated PDCCH or may be defined in standards (e.g., 3GPP standards). Thus, the duration of the receptionTimer 740 shown in FIG. 7 is only exemplary and other durations may be used.

While the receptionTimer 740 is running, the UE 110 may continue to monitor the PDCCH from the gNB 120A, e. g., beyond the boundary of the active duration 712. When the receptionTimer 740 expires, the UE 110 will discontinue monitoring the PDCCH during the remaining inactive duration 714. Thus, these exemplary embodiments show a further manner of extending the active duration of the DTX cycle of the gNB 120A.

Continuing with the example of FIG. 7, the second scenario will be considered, e.g., gNB 120A in DTX mode and UE 110 in C-DRX mode. As shown in FIG. 7, the UE 110 may again receive a UE dedicated PDCCH 730 during the active duration 712. However, because the UE 110 is in the C-DRX mode, the UE 110 will start the inactivityTimer 750. Those skilled in the art will understand that the inactivityTimer 750 is configured to extend the active duration of the C-DRX cycle because when the UE 110 receives the UE dedicated PDCCH 730, it is considered that the UE 110 is likely to receive additional PDCCH. Thus, the inactivityTimer 750 is started to keep the UE 110 listening for additional PDCCH. In these exemplary embodiments, the reception of the UE dedicated PDCCH 730 during the active duration, will also cause the UE 110 to start the receptionTimer 740. As described above, the receptionTimer 740 is also used to keep the UE 110 monitoring for PDCCH after the boundary of the active duration 712.

Since, in this scenario, there may be two timers started at the same time and running for the same purpose (e.g., to extend the time the UE 110 is monitoring for PDCCH beyond the boundary of the active duration 712), there may be various options to handle the timers. Each of these options will be described in greater detail below.

In a first option, the UE 110 may monitor for PDCCH based on max (ReceptionTimer, inactivityTimer), e.g., for the longer of the duration associated with the ReceptionTimer 740 or the inactivityTimer 750.

In a second option, the UE 110 may monitor for PDCCH based on min (ReceptionTimer, inactivityTimer), e. g., for the shorter of the duration associated with the ReceptionTimer 740 or the inactivityTimer 750.

In a third option, the UE 110 may monitor PDCCH based on the ReceptionTimer 740. In this option, the UE 110 may not start the inactivityTimer 750. For example, the UE 110 has the cell DTX configuration for the gNB 120A and is aware of whether cell DTX is activated. The UE 110 similarly has the C-DRX configuration for the UE 110. Thus, if the UE 110 receives the UE dedicated PDCCH 730 during the active duration 712 and understands both cell DTX and C-DRX are active, the UE 110 will only start the ReceptionTimer 740.

In a fourth option, the UE 110 may monitor PDCCH based on the inactivityTimer 750. In this option, the UE 110 may not start the ReceptionTimer 740. Similar to the third option, if the UE 110 receives the UE dedicated PDCCH 730 during the active duration 712 and understands both cell DTX and C-DRX are active, the UE 110 will only start the inactivityTimer 750.

Similar to the above exemplary embodiments, RRC may also configure whether retransmissions are allowed. If retransmissions are allowed, the UE may follow a legacy UE DRX behavior as described above. If retransmissions are not allowed, the UE stops the HARQ-RTT-timer or the HARQ-ReTX-timer (if running), or alternatively the UE simply refrains from starting the HARQ-RTT-timer.

In additional exemplary embodiments, during inactive durations of the cell DTX/DRX cycle, the gNB 120A may configure whether the UE 110 in the RRC INACTIVE state can perform mobile originating (MO) and/or mobile terminating small data transmissions. For MO-SDT, the gNB 120A may additionally configure a logical channel (LCH) priority threshold. For example, when the SDT Data Radio Bearer Signaling Radio Bearer (SDT-DRB-SRB2) associated with an LCH priority is greater than a threshold, the UE can initiate Random Access Channel (RACH) based MO-SDT.

The gNB 120A may also configure whether the UE 110 in the RRC_CONNECTED state can perform MO and/or MT SDT. For MO-SDT, the gNB 120A can additionally configure a LCH priority threshold, where the UE 110 may initiate RACH based MO-SDT when the SDT-DRB-SRB2 associated with the LCH priority is greater than a threshold.

Furthermore, when the UE 110 is in an active duration of the DTX cycle and also in the ra-ResponseWindow or the ra-ContentionResolutionTimer is running, the UE 110 should monitor the PDCCH.

When the UE 110 enters the inactive duration of cell DRX, the UE 110 may stop all configured grant timers and configured grant retransmission timers, if running.

### EXAMPLES

In a first example, a method performed by a user equipment (UE), comprising receiving a cell discontinuous transmission (DTX) configuration for a base station, wherein the cell DTX configuration comprises a cell DTX cycle comprising an active duration where the UE monitors for downlink (DL) signals from the base station and an inactive duration where the UE does not monitor for DL signals from the base station, receiving a message from the base station, starting a timer based on the message, wherein the timer runs for a predetermined duration and during the predetermined duration, monitoring for DL signals from the base station, wherein at least a portion of the monitoring is performed during the inactive duration.

In a second example, the method of the first example, wherein the DL signals comprise Physical Downlink Control Channel (PDCCH) signals comprising a Cell Radio Network Temporary Identifier (C-RNTI) corresponding to the UE.

In a third example, the method of the first example, further comprising receiving a paging occasion (PO) configuration for the base station, wherein one or more POs are scheduled for the inactive duration.

In a fourth example, the method of the third example, further comprising monitoring the one or more POs, wherein the message is a paging message comprising scheduling information received during one of the one or more POs and the timer is started based on receiving the paging message.

In a fifth example, the method of the fourth example, further comprising determining whether the paging message comprises a UE identification (UE ID) corresponding to the UE and stopping the timer prior to an expiration of the predetermined duration when the paging message does not include the UE ID.

In a sixth example, the method of the fifth example, further comprising determining whether the paging message comprises a predetermined paging cause and stopping the timer prior to the expiration of the predetermined duration when the paging message does not include the predetermined paging cause.

In a seventh example, the method of the fourth example, wherein the paging message comprises an early paging indication (PEI).

In an eighth example, the method of the third example, further comprising monitoring the one or more POs, wherein the message is a paging message comprising scheduling information received during one of the one or more POs and determining the paging message comprises a UE identification (UE ID) corresponding to the UE, wherein the timer is started based on the paging message including the UE ID.

In a ninth example, the method of the eighth example, further comprising determining the paging message comprises a predetermined paging cause, wherein the timer is started based on the paging message including the UE ID and the predetermined paging cause.

In a tenth example, the method of the ninth example, wherein the predetermined paging cause is a voice data paging cause.

In an eleventh second example, the method of the first example, further comprising receiving a configured periodic resource configuration for the base station, wherein one or more configured periodic resources are scheduled for the inactive duration and monitoring the one or more configured periodic resources, wherein the message is a group common PDCCH or cell common PDCCH received during one of the one or more configured periodic resources and the timer is started based on receiving the group common PDCCH or the cell common PDCCH.

In a twelfth example, the method of the eleventh example, wherein the configured periodic resource configuration comprises a periodicity of the configured periodic resources, a duration of the configured periodic resources, or an offset of the configured periodic resources.

In a thirteenth example, the method of the eleventh example, wherein the group common PDCCH or the cell common PDCCH comprises a paging short message, a Downlink Control Information (DCI) Format 2-6, or a DCI Format 2-7.

In a fourteenth example, the method of the second example, further comprising receiving a retransmission configuration indicating whether retransmissions are allowed for PDCCH signals received during the inactive duration, receiving a PDCCH signal during the inactive duration and transmitting, to the base station, Hybrid Automatic Repeat Request (HARQ) feedback corresponding to the PDCCH signal.

In a fifteenth example, the method of the fourteenth example, further comprising when the retransmission configuration indicates that retransmissions are not allowed, stopping monitoring a Physical Downlink Control Channel (PDCCH) for an indication of a retransmission after transmitting the HARQ feedback.

In a sixteenth example, the method of the fourteenth example, further comprising when the retransmission configuration indicates that retransmissions are allowed, starting a first retransmission timer after transmitting the HARQ feedback, stopping monitoring a physical downlink control channel (PDCCH) for an indication of a retransmission before the first retransmission timer expires, starting a second retransmission timer after the first retransmission timer expires and monitoring the PDCCH for an indication of the retransmission after the first retransmission timer expires and before the second retransmission timer expires.

In a seventeenth example, a processor of a user equipment (UE) configured to perform any of the methods of the first through sixteenth examples.

In an eighteenth example, a user equipment (UE) comprising a transceiver configured to communicate with a base station and a processor communicatively coupled to the transceiver and configured to perform any of the methods of the first through sixteenth examples.

In a nineteenth example, a method performed by a user equipment (UE), comprising receiving a cell discontinuous transmission (DTX) configuration for a base station, wherein the cell DTX configuration comprises a cell DTX cycle comprising an active duration where the UE monitors for downlink (DL) signals from the base station and an inactive duration where the UE does not monitor for DL signals from the base station, receiving a UE dedicated PDCCH from the base station during the active duration and determining whether the UE is operating in Connected Discontinuous Reception (C-DRX) mode.

In a twentieth example, the method of the nineteenth example, further comprising when the UE is not operating in C-DRX mode, starting a first timer based on receiving the UE dedicated PDCCH, wherein the timer runs for a predetermined duration and during the predetermined duration, monitoring for DL signals from the base station, wherein at least a portion of the monitoring is performed during the inactive duration.

In a twenty first example, the method of the nineteenth example, further comprising when the UE is operating in C-DRX mode, starting a first timer and a second timer based on receiving the UE dedicated PDCCH, wherein the first timer runs for a first predetermined duration and the second timer runs for a second predetermined duration and during one of the first predetermined duration or second predetermined duration, monitoring for DL signals from the base station, wherein at least a portion of the monitoring is performed during the inactive duration.

In a twenty second example, the method of the twenty first example, wherein the one of the first predetermined duration or the second predetermined duration is based on a longer of the first predetermined duration or the second predetermined duration.

In a twenty third example, the method of the twenty first example, wherein the one of the first predetermined duration or the second predetermined duration is based on a shorter of the first predetermined duration or the second predetermined duration.

In a twenty fourth example, the method of the nineteenth example, further comprising when the UE is operating in C-DRX mode, starting one of a first timer or a second timer based on receiving the UE dedicated PDCCH, wherein the first timer is associated with the cell DTX configuration and runs for a first predetermined duration and the second timer is associated with the C-DRX mode and runs for a second predetermined duration and during one of the first predetermined duration or second predetermined duration, monitoring for DL signals from the base station, wherein at least a portion of the monitoring is performed during the inactive duration.

In a twenty fifth example, the method of the twenty fourth example, wherein the one of the first timer or the second timer is the first timer.

In a twenty sixth example, the method of the twenty fourth example, wherein the one of the first timer or the second timer is the second timer.

In a twenty seventh example, a processor of a user equipment (UE) configured to perform any of the methods of the nineteenth through twenty sixth examples.

In an twenty eighth example, a user equipment (UE) comprising a transceiver configured to communicate with a base station and a processor communicatively coupled to the transceiver and configured to perform any of the methods of the nineteenth through twenty sixth examples.

In a twenty ninth example, a method performed by a user equipment (UE), comprising receiving a cell discontinuous transmission (DTX) configuration for a base station, wherein the cell DTX configuration comprises a cycle comprising an active duration and an inactive duration, receiving a first small data transmission (SDT) configuration for a radio resource control (RRC) inactive state indicating when the UE can perform SDT during the inactive durations of the cell DTX cycle in the RRC inactive state, receiving a second SDT configuration for a RRC connected state indicating when the UE can perform SDT during the inactive durations of the cell DTX cycle in the RRC connected state and performing SDT in a downlink during the inactive durations of the cell DTX cycle based on the first and second SDT configurations.

In a thirtieth example, a processor of a user equipment (UE) configured to perform the method of the twenty ninth example.

In an thirty first example, a user equipment (UE) comprising a transceiver configured to communicate with a base station and a processor communicatively coupled to the transceiver and configured to perform the method of the twenty ninth example.

In a thirty second example, a method performed by a user equipment (UE), comprising receiving a cell discontinuous reception (DRX) configuration for a base station, wherein the cell DRX configuration comprises a cycle comprising an active duration and an inactive duration, receiving a first small data transmission (SDT) configuration for a radio resource control (RRC) inactive state indicating when the UE can perform SDT during the inactive durations of the cell DRX cycle in the RRC inactive state, receiving a second SDT configuration for a RRC connected state indicating when the UE can perform SDT during the inactive durations of the cell DRX cycle in the RRC connected state and performing SDT in an uplink during the inactive durations of the cell DRX cycle based on the first and second SDT configurations.

In a thirty third example, the method of the thirty second example, wherein the first SDT configuration comprises a logical channel (LCH) priority threshold, wherein the UE is permitted to perform SDT when a SDT Data Radio Bearer Signaling Radio Bearer (SDT-DRB-SRB2) associated with an LCH priority is greater than the LCH priority threshold.

In a thirty fourth example, the method of the thirty second example, wherein the second SDT configuration comprises a logical channel (LCH) priority threshold, wherein the VE is permitted to perform SDT when a SDT Data Radio Bearer Signaling Radio Bearer (SDT-DRB-SRB2) associated with an LCH priority is greater than the LCH priority threshold.

In a thirty fifth example, a processor of a user equipment (UE) configured to perform any of the methods of the thirty second through thirty fourth examples.

In a thirty sixth example, a user equipment (UE) comprising a transceiver configured to communicate with a base station and a processor communicatively coupled to the transceiver and configured to perform any of the methods of the thirty second through thirty fourth examples.

In a thirty seventh example, a method performed by a user equipment (UE), comprising receiving a cell discontinuous transmission (DTX) configuration for a base station, wherein the cell DTX configuration comprises a cycle comprising an active duration and an inactive duration and when the UE is in the active duration of the cell DTX cycle and also in a ra-ResponseWindow or a ra-ContentionResolutionTimer is running, monitoring a Physical Downlink Control Channel (PDCCH) of the base station.

In a thirty eighth example, a processor of a user equipment (UE) configured to perform the method of the thirty seventh example.

In a thirty ninth example, a user equipment (UE) comprising a transceiver configured to communicate with a base station and a processor communicatively coupled to the transceiver and configured to perform the method of the thirty seventh example.

In a fortieth example, a method performed by a user equipment (UE), comprising receiving a cell discontinuous reception (DRX) configuration for a base station, wherein the cell DRX configuration comprises a cycle comprising an active duration and an inactive duration and when the UE is in the inactive duration of the cell DRX cycle, stopping all configured grant timers and configured grant retransmission timers.

In a forty first example, a processor of a user equipment (UE) configured to perform the method of the fortieth example.

In a forty second example, a user equipment (UE) comprising a transceiver configured to communicate with a base station and a processor communicatively coupled to the transceiver and configured to perform the method of the fortieth example.

In a forty third example, a method performed by a base station, comprising transmitting, to a user equipment (UE), a cell discontinuous transmission (DTX) configuration for the base station, wherein the cell DTX configuration comprises a cell DTX cycle comprising an active duration where the UE monitors for downlink (DL) signals from the base station and an inactive duration where the UE does not monitor for DL signals from the base station and transmitting a message to the UE, wherein the message causes the UE to monitor for DL signals from the base station during a portion of the inactive duration, wherein the DL signals comprise Physical Downlink Control Channel (PDCCH) signals comprising a Cell Radio Network Temporary Identifier (C-RNTI) corresponding to the UE.

In a forty fourth example, the method of the forty third example, further comprising sending a paging occasion (PO) configuration for the base station, wherein one or more POs are scheduled for the inactive duration, wherein the message is a paging message transmitted during one of the one or more POS.

In a forty fifth example, the method of the forty fourth example, wherein the paging message comprises scheduling information.

In a forty sixth example, the method of the forty fourth example, wherein the paging message comprises a UE identification (UE ID) corresponding to the UE.

In a forty seventh example, the method of the forty fifth example, wherein the paging message further comprises a predetermined paging cause, wherein the predetermined paging cause is a voice data paging cause.

In a forty eighth example, the method of the forty fourth example, wherein the paging message comprises an early paging indication (PEI).

In a forty ninth example, the method of the forty third example, further comprising transmitting a configured periodic resource configuration for the base station, wherein one or more configured periodic resources are scheduled for the inactive duration and wherein the message is a group common PDCCH or cell common PDCCH transmitted during one of the one or more configured periodic resources.

In a fiftieth example, the method of the forty ninth example, wherein the configured periodic resource configuration comprises a periodicity of the configured periodic resources, a duration of the configured periodic resources, or an offset of the configured periodic resources.

In a fifty first example, the method of the forty ninth example, wherein the group common PDCCH or the cell common PDCCH comprises a paging short message, a Downlink Control Information (DCI) Format 2-6, or a DCI Format 2-7.

In a fifty second example, the method of the forty third example, wherein the message is a UE dedicated PDCCH transmitted during the active duration.

In a fifty third example, the method of the forty third example, further comprising sending a retransmission configuration related to DL signals transmitted during the inactive duration and performing retransmission operations in accordance with the retransmission configuration.

In a fifty fourth example, a processor of a base station configured to perform any of the methods of the forty third through fifty third examples.

In a fifty fifth example, a base station comprising a transceiver configured to communicate with a user equipment (UE) and a processor communicatively coupled to the transceiver and configured to perform any of the methods of the forty third through fifty third examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE), comprising:
receiving a cell discontinuous transmission (DTX) configuration for a base station, wherein the cell DTX configuration comprises a cell DTX cycle comprising an active duration where the UE monitors for downlink (DL) signals from the base station and an inactive duration where the UE does not monitor for DL signals from the base station;
receiving a message from the base station;
starting a timer based on the message, wherein the timer runs for a predetermined duration; and
during the predetermined duration, monitoring for DL signals from the base station, wherein at least a portion of the monitoring is performed during the inactive duration.

2. The method of claim 1, wherein the DL signals comprise Physical Downlink Control Channel (PDCCH) signals comprising a Cell Radio Network Temporary Identifier (C-RNTI) corresponding to the UE.

3. The method of claim 1, further comprising:
receiving a paging occasion (PO) configuration for the base station, wherein one or more POs are scheduled for the inactive duration.

4. The method of claim 3, further comprising:
monitoring the one or more POs, wherein the message is a paging message comprising scheduling information received during one of the one or more POs and the timer is started based on receiving the paging message.

5. The method of claim 4, further comprising:
determining whether the paging message comprises a UE identification (UE ID) corresponding to the UE; and
stopping the timer prior to an expiration of the predetermined duration when the paging message does not include the UE ID.

6. The method of claim 5, further comprising:
determining whether the paging message comprises a predetermined paging cause; and
stopping the timer prior to the expiration of the predetermined duration when the paging message does not include the predetermined paging cause.

7. The method of claim 4, wherein the paging message comprises an early paging indication (PEI).

8. The method of claim 3, further comprising:
monitoring the one or more POs, wherein the message is a paging message comprising scheduling information received during one of the one or more POs; and
determining the paging message comprises a UE identification (UE ID) corresponding to the UE, wherein the timer is started based on the paging message including the UE ID.

9. The method of claim 8, further comprising:
determining the paging message comprises a predetermined paging cause, wherein the timer is started based on the paging message including the UE ID and the predetermined paging cause.

10. The method of claim 9, wherein the predetermined paging cause is a voice data paging cause.

11. The method of claim 1, further comprising:
receiving a configured periodic resource configuration for the base station, wherein one or more configured periodic resources are scheduled for the inactive duration; and
monitoring the one or more configured periodic resources, wherein the message is a group common PDCCH or cell common PDCCH received during one of the one or more configured periodic resources and the timer is started based on receiving the group common PDCCH or the cell common PDCCH.

12. The method of claim 11, wherein the configured periodic resource configuration comprises a periodicity of the configured periodic resources, a duration of the configured periodic resources, or an offset of the configured periodic resources.

13. The method of claim 11, wherein the group common PDCCH or the cell common PDCCH comprises a paging short message, a Downlink Control Information (DCI) Format 2-6, or a DCI Format 2-7.

14. The method of claim 2, further comprising:
receiving a retransmission configuration indicating whether retransmissions are allowed for PDCCH signals received during the inactive duration;
receiving a PDCCH signal during the inactive duration; and
transmitting, to the base station, Hybrid Automatic Repeat Request (HARQ) feedback corresponding to the PDCCH signal.

15. The method of claim 14, further comprising:
when the retransmission configuration indicates that retransmissions are not allowed, stopping monitoring a Physical Downlink Control Channel (PDCCH) for an indication of a retransmission after transmitting the HARQ feedback.

16. The method of claim 14, further comprising:
when the retransmission configuration indicates that retransmissions are allowed, starting a first retransmission timer after transmitting the HARQ feedback;
stopping monitoring a physical downlink control channel (PDCCH) for an indication of a retransmission before the first retransmission timer expires;
starting a second retransmission timer after the first retransmission timer expires; and
monitoring the PDCCH for an indication of the retransmission after the first retransmission timer expires and before the second retransmission timer expires.

17. A method performed by a user equipment (UE), comprising:
receiving a cell discontinuous transmission (DTX) configuration for a base station, wherein the cell DTX configuration comprises a cell DTX cycle comprising an active duration where the UE monitors for downlink (DL) signals from the base station and an inactive duration where the UE does not monitor for DL signals from the base station;
receiving a UE dedicated PDCCH from the base station during the active duration; and
determining whether the UE is operating in Connected Discontinuous Reception (C-DRX) mode.

18. The method of claim 17, further comprising:
when the UE is not operating in C-DRX mode, starting a first timer based on receiving the UE dedicated PDCCH, wherein the timer runs for a predetermined duration; and
during the predetermined duration, monitoring for DL signals from the base station, wherein at least a portion of the monitoring is performed during the inactive duration.

19. The method of claim 17, further comprising:
when the UE is operating in C-DRX mode, starting a first timer and a second timer based on receiving the UE dedicated PDCCH, wherein the first timer runs for a first predetermined duration and the second timer runs for a second predetermined duration; and
during one of the first predetermined duration or second predetermined duration, monitoring for DL signals from the base station, wherein at least a portion of the monitoring is performed during the inactive duration.

20-21. (canceled)

22. The method of claim 17, further comprising:
when the UE is operating in C-DRX mode, starting one of a first timer or a second timer based on receiving the UE dedicated PDCCH, wherein the first timer is associated with the cell DTX configuration and runs for a first predetermined duration and the second timer is associated with the C-DRX mode and runs for a second predetermined duration; and
during one of the first predetermined duration or second predetermined duration, monitoring for DL signals from the base station, wherein at least a portion of the monitoring is performed during the inactive duration.

23-24. (canceled)
